(19) United States
(12) Patent Application Publication
(10) Pub. No.: US 2011/0123327 A1
(43) Pub. Date: May 26, 2011

(54) BEARING ASSEMBLY USING DIFFERENT TYPE THRUST BEARINGS

(75) Inventors: Edward Arthur Dewhurst, Niskayuna, NY (US); Srikanth Mathod, Bangalore (IN); Eric Thomas Montrym, Schenectady, NY (US); Mayank Rajoria, Bangalore (IN)

(73) Assignee: GENERAL ELECTRIC COMPANY, Schenectady, NY (US)

(21) Appl. No.: 12/622,767

(22) Filed: Nov. 20, 2009

(51) Int. Cl. F01D 25/16; F16C 17/00

(52) U.S. Cl. 415/229; 384/309

(57) ABSTRACT

A bearing assembly includes a thrust bearing casing surrounding a rotating shaft at a location intermediate ends of the rotating shaft, the rotating shaft including an active side shaft thrust plate and an inactive side shaft thrust plate, each of the active side and the inactive side shaft thrust plate affixed to and extending radially from the rotating shaft, wherein the active side shaft thrust plate receives a substantially larger axial force compared to the inactive side shaft thrust plate during operation of the rotating shaft; a first thrust bearing between the thrust bearing casing and the active side shaft thrust plate; and a second thrust bearing between the thrust bearing casing and the inactive side shaft thrust plate. The first thrust bearing and the second thrust bearing are of a different type, e.g., a tilting pad bearing and a land bearing including a tapered land and/or flat land.

### BACKGROUND

1. Technical Field

The disclosure relates generally to machinery including a rotating shaft, and more particularly, to a bearing assembly for the rotating shaft using two thrust bearings of different types.

2. Background Art

Machines routinely include rotating shafts that must be supported by bearing assemblies. For example, turbo machines such as steam or gas turbines that operate using axial flow have rotating shafts that are subjected to axial thrusts in two directions. In order to resist the bi-directional axial forces, the rotating shaft includes two thrust plates or runners extending therefrom that exert axial force against a thrust bearing assembly. The thrust bearing assembly includes two identical tilting pad, thrust bearings on either side of the assembly, each of which bear against the thrust plates and can absorb the full axial force in either direction.

### BRIEF SUMMARY

A first aspect of the disclosure provides a bearing assembly comprising: a thrust bearing casing surrounding a rotating shaft at a location intermediate ends of the rotating shaft, the rotating shaft including an active side shaft thrust plate and an inactive side shaft thrust plate, each of the active side and the inactive side shaft thrust plate affixed to and extending radially from the rotating shaft, wherein the active side shaft thrust plate receives a substantially larger axial force compared to the inactive side shaft thrust plate during operation of the rotating shaft; a first thrust bearing between the thrust bearing casing and the active side shaft thrust plate; and a second thrust bearing between the thrust bearing casing and the inactive side shaft thrust plate, wherein the first thrust bearing and the second thrust bearing are of a different type.

A second aspect of the disclosure provides a machine comprising: a rotating shaft including an active side shaft thrust plate and an inactive side shaft thrust plate, each of the active side and the inactive side shaft thrust plate affixed to and extending radially from the rotating shaft, wherein the active side shaft thrust plate receives a substantially larger axial force compared to the inactive side shaft thrust plate during operation of the rotating shaft; a bearing assembly for supporting the rotating shaft, the bearing assembly including: a thrust bearing casing surrounding the rotating shaft at a location intermediate ends of the rotating shaft, a first thrust bearing between the thrust bearing casing and the active side shaft thrust plate; and a second thrust bearing between the thrust bearing casing and the inactive side shaft thrust plate, wherein the first thrust bearing and the second thrust bearing are of a different type.

A third aspect of the disclosure provides a bearing assembly comprising: a thrust bearing casing surrounding a rotating shaft, the thrust bearing casing including an active side casing thrust plate and an inactive side casing thrust plate, each of the active side and the inactive side casing thrust plate extending radially toward a rotating shaft, the rotating shaft including a shaft thrust plate affixed to and extending radially from the rotating shaft within the thrust bearing casing, wherein the active side casing thrust plate receives a substantially larger axial force compared to the inactive side casing thrust plate during operation of the rotating shaft; a first thrust bearing between the shaft thrust plate and the active side casing thrust plate; and a second thrust bearing between the shaft thrust plate and the inactive side casing thrust plate, wherein the first thrust bearing and the second thrust bearing are of a different type.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a partial cross-sectional view of an illustrative machine incorporating a bearing assembly according to embodiments of the invention.

FIG. 2 shows a cross-sectional view of a bearing assembly according to embodiments of the invention.

FIG. 3 shows a cross-sectional view of an illustrative tilting pad bearing usable with embodiments of the invention.

FIG. 4 shows a cross-sectional view of an illustrative tapered or flat land bearing usable with embodiments of the invention.

FIG. 5 shows a cross-sectional view of a bearing assembly according to other embodiments of the invention.

FIG. 6 shows a cross-sectional view of a bearing assembly according to another embodiment of the invention.

FIG. 7 shows a cross-sectional view of a bearing assembly according to other embodiments of the invention.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

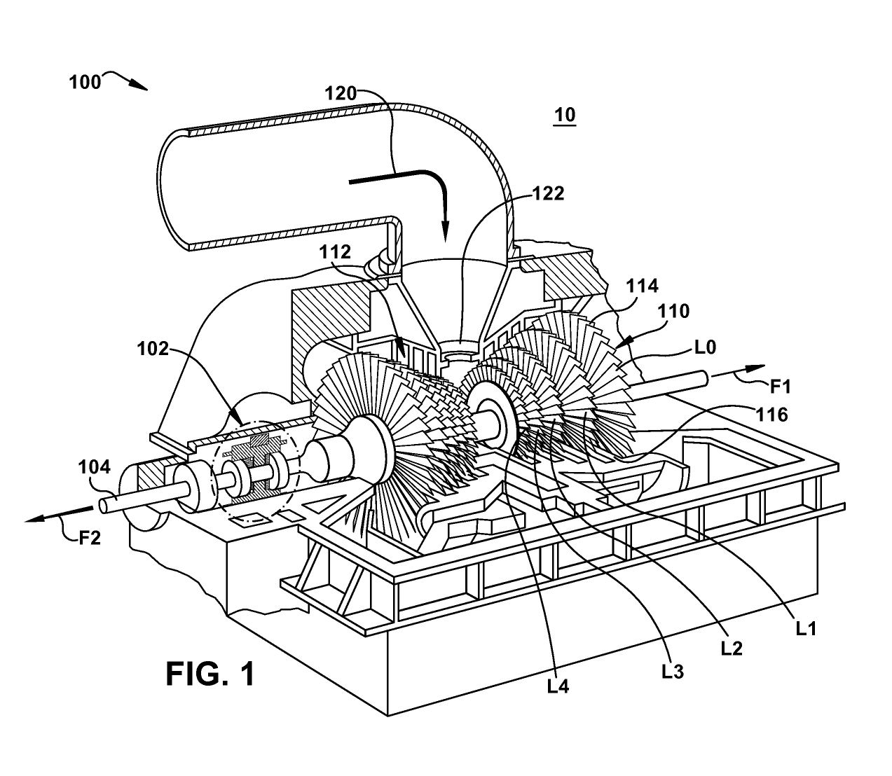

Referring to FIG. 1, an illustrative machine 100 incorporating a bearing assembly 102 (shown in simplified form) for a rotating shaft 104 according to embodiments of the invention is shown. In the example, machine 100 includes a turbo machine such as a steam or gas turbine. It is understood, however, that bearing assembly 102 may be applied to any machine 100 including a rotating shaft 104 that is subject to axial thrust forces F1, F2, i.e., substantially along an axis of the rotating shaft. Other examples include but are not limited to: percussive drills, motors and generators.

FIG. 1 shows a perspective partial cut-away illustration of machine 100 in the form of a steam turbine (a gas turbine is substantially similar in concept). The invention will be described relative to a steam turbine for illustrative purposes only, it is not intended to limit the invention. Machine 100 includes a rotor 110 that includes rotating shaft 104 and a plurality of axially spaced rotor wheels 112. A plurality of rotating blades 114 are mechanically coupled to each rotor wheel 112. More specifically, blades 114 are arranged in rows that extend circumferentially around each rotor wheel 112. A plurality of stationary vanes 116 extend circumferentially around shaft 104, and the vanes are axially positioned between adjacent rows of blades 114. Stationary vanes 116 cooperate with blades 114 to form a stage and to define a portion of an operative fluid flow path through the turbine.

In operation, an operative fluid 120 such as steam or a gas enters an inlet 122 of the turbine and is channeled through stationary vanes 116. Vanes 116 direct operative fluid 120 downstream against blades 114. Operative fluid 120 passes through the remaining stages imparting a rotational force on blades 114 causing shaft 104 to rotate. In addition, due to the axial flow of operative fluid 120 and various pressure drops across the stages, rotating shaft 104 also receives bi-directional axial forces F1 and F2. However, during the operation of the turbine, the axial force load is typically in one direction, e.g., force F1 direction. At least one end of the turbine may extend axially away from rotor 110 and may be attached to a load or machinery (not shown) such as, but not limited to, a generator, and/or another turbine.

In one embodiment of the present invention as shown in FIG. 1, the turbine comprises five stages. The five stages are referred to as L0, L1, L2, L3 and L4. Stage L4 is the first stage and is the smallest (in a radial direction) of the five stages, and stage L0 is the last stage and is the largest (in a radial direction). It is to be understood that five stages are shown as one example only, and each turbine may have more or less than five stages. In addition, as noted above, the teachings of the invention are not limited to a multiple stage turbine, and are applicable to any machine 100 including a rotating shaft 104 that is subject to axial thrust forces F1, F2, i.e., substantially along an axis of the rotating shaft.

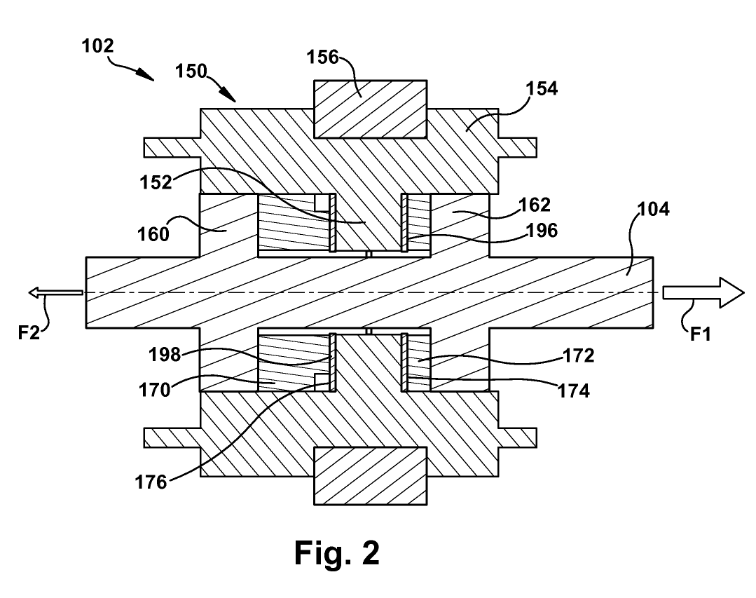

Turning to FIG. 2, a cross sectional view showing details of bearing assembly 102 is provided. Typically, bearing assembly 102 is provided at one or more locations intermediate ends of rotating shaft 104 for transferring thrust forces to a foundation of machine 100 to which the bearing assembly is connected either directly or indirectly. However, bearing assembly 102 may be employed at an end of rotating shaft 104 also. One or more rotationally supportive journal bearing(s) (not shown) may be positioned elsewhere along a length of rotating shaft 104 for rotational support. Bearing assembly 102 includes a thrust bearing casing 150, which may include any structure and other bearing support structure now known or later developed for positioning thrust bearings relative to rotating shaft 104. Thrust bearing casing 150 surrounds rotating shaft 104. Thrust bearing casing 150 may be made of separate pieces or integral construction, and may also be integral with a foundation structure 156 that is fixed to a foundation, or may include other structure for coupling to the foundation of machine 100. In this embodiment, thrust bearing casing 150 includes a casing thrust plate 152. Thrust bearing casing 150 is rotationally fixed by a collar 154 that positions casing thrust plate 152 and is coupled to foundation structure 156.

Rotating shaft 104 includes an active side shaft thrust plate 160 and an inactive side shaft thrust plate 162. Thrust plates 160, 162 may also be referred to in the art as runners. Each of active side shaft thrust plate 160 and inactive side shaft thrust plate 162 is affixed to, and extends radially from, rotating shaft 104. Plates 160, 162 may be separate coupled pieces to rotating shaft 104, or they may be integral to rotating shaft 104. As will be described in greater detail herein, active side shaft thrust plate 160 is so denoted because it receives a substantially larger force compared to inactive side shaft thrust plate 162 during operation of rotating shaft 104.

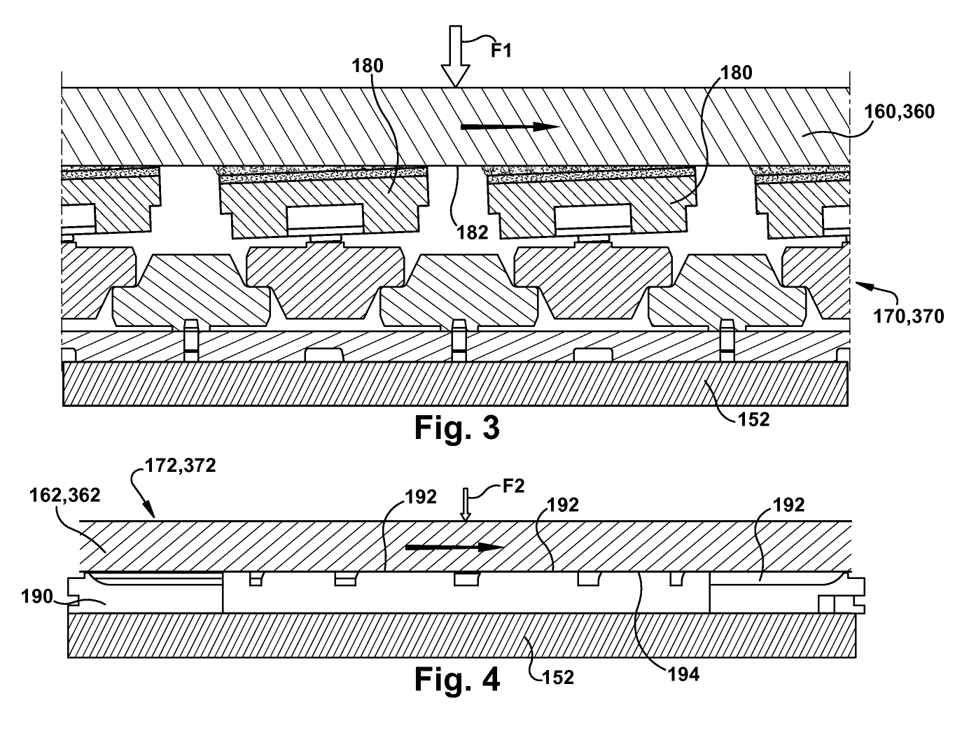

Bearing assembly 102 also includes a first thrust bearing 170 between thrust bearing casing 150, i.e., casing thrust plate 152, and active side shaft thrust plate 160, and a second thrust bearing 172 between thrust bearing casing 152, i.e., casing thrust plate 152, and inactive side shaft thrust plate 162. In conventional arrangements, both thrust bearings 170, 172 would include a tilting pad bearing. In contrast to conventional arrangements, however, thrust bearings 170, 172 are of different types. That is, one is a first type and the other is a second type and the first type is not the second type, for example, the bearings 170, 172 are not both tilting pad thrust bearings. In one embodiment, first thrust bearing 170 includes a conventional tilting pad thrust bearing. One example of a tilting pad thrust bearing 170 is shown in FIG. 3. As understood in the art, tilting pad thrust bearings employ a number of pads 180 that are tillable relative to a surface 182, i.e., of active side shaft thrust plate 160, to bear. A thin film of oil acts to lubricate the surfaces. In one embodiment, second thrust bearing 172 includes a tapered or flat land bearing. One example of a tapered or flat land thrust bearing 172 (herein referred to collectively as “land bearing”) is shown in FIG. 4. A land thrust bearing 172 may include a plate 190 having a number of tapered or flat lands 192 on a surface thereof that receive a surface 194, i.e., of inactive side shaft thrust plate 162, to bear. A thin film of oil acts to lubricate the surfaces. A land bearing that uses a combination of tapered and flat lands may also be used.

Returning to FIG. 2, land thrust bearing 172 is substantially thinner in an axial direction compared to tilting pad thrust bearing 170, resulting in an asymmetrical arrangement relative to casing thrust plate 152, collar 154 and/or foundation structure 156. This situation is non-existent in conventional bearing assemblies. In one embodiment, to accommodate the asymmetrical arrangement, casing thrust plate 152 is disposed closer to inactive side shaft thrust plate 162 than to active side shaft thrust plate 160. That is, casing thrust plate 152 is asymmetrically disposed relative to collar 154 and/or foundation structure 156 so as to have a surface 196 thereof closer to inactive side thrust plate 162 compared to an opposing surface 198 thereof distance to active side thrust plate 160. In addition, as shown in FIG. 2, one or more spacers or shims 174 and/or 176 may be provided to allow for proper positioning of parts. Each spacer 174 or 176 may include a collar having an aperture therethrough for rotating shaft 104.

In operation, active side shaft thrust plate 160 may receive axial force F1, which is substantially larger than and more consistent than axial thrust force F2 received by inactive side shaft thrust plate 162. More specifically, as axial force F1 load is exerted between active side shaft thrust plate 160 and casing thrust plate 152, and first thrust bearing 170 includes a bearing of a type, e.g., a tilting pad bearing, sufficiently structurally robust to absorb force F1. In contrast, axial force F2 load is exerted between inactive side shaft thrust plate 162 and casing thrust plate 152, and second thrust bearing 172 includes a bearing of a type, e.g., a land bearing, sufficiently structurally robust to absorb the lesser, transient force F2.

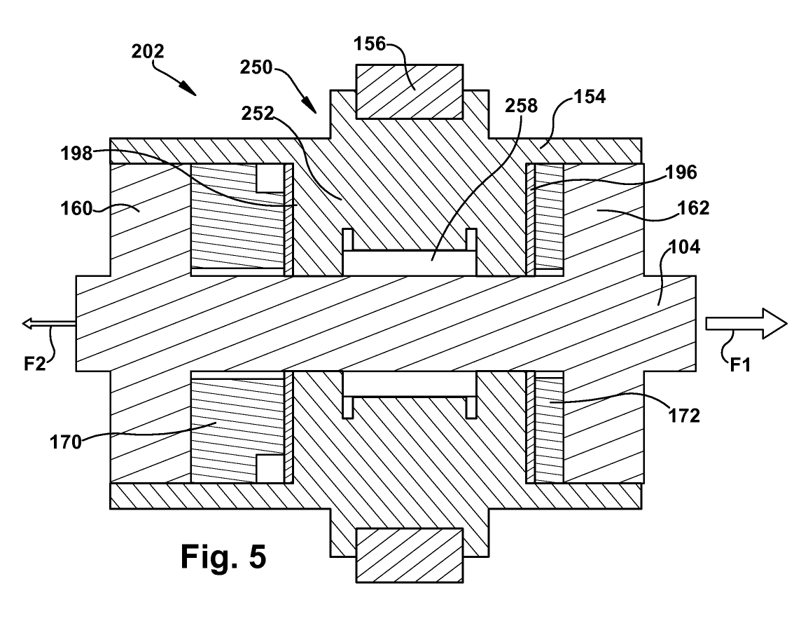

Turning to FIG. 5, a cross-sectional view of another embodiment of a bearing assembly 202 is illustrated. Bearing assembly 202 is substantially similar to bearing assembly 102 of FIG. 2, except that thrust bearing casing 250 includes a casing thrust plate 252 with a journal bearing 258 positioned therein. In this fashion, bearing assembly 202 performs the same functions as that described above for bearing assembly 102, and also provides rotational support to rotating shaft 104.

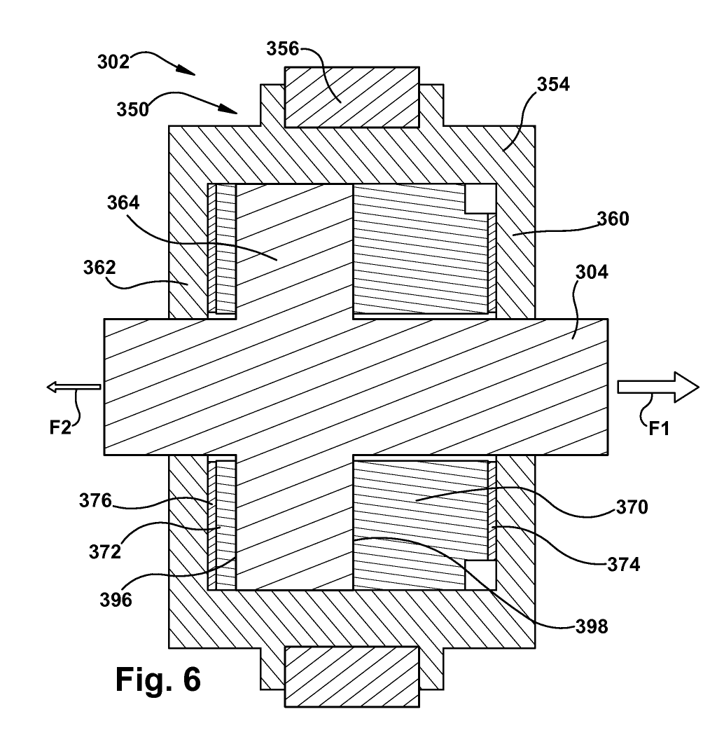

Referring to FIG. 6, a cross-sectional view of another embodiment of a bearing assembly 302 is illustrated. Bearing assembly 302 is provided at one or more locations intermediate ends of a rotating shaft 304 for transferring thrust forces to a foundation of machine 100 (FIG. 1) to which the bearing assembly is connected either directly or indirectly. However, bearing assembly 302 may be employed at an end of rotating shaft 304 also. Bearing assembly 302 includes a thrust bearing casing 350, which may include any structure and other bearing support structure now known or later developed for positioning thrust bearings relative to rotating shaft 304. Thrust bearing casing 350 surrounds rotating shaft 304. Thrust bearing casing 350 may be made of separate pieces or integral construction, and may also be integral with a foundation structure 356 that is fixed to a foundation, or may include other structure for coupling to the foundation of machine 100 (FIG. 1). In this embodiment, thrust bearing casing 350 includes an active side casing thrust plate 360 and an inactive side casing thrust plate 362. Each of active side and inactive side casing thrust plates 360, 362 extend radially toward rotating shaft 304. Thrust bearing casing 350 is rotationally fixed by a collar 354 that positions casing thrust plates 360, 362 and is coupled to foundation structure 356. Plates 360, 362 may be separate coupled pieces to collar 354, or they may be integral to collar 354. As will be described in greater detail herein, active side casing thrust plate 360 is so denoted because it receives a substantially larger force compared to inactive side casing thrust plate 362 during operation of rotating shaft 304.

Rotating shaft 304 includes a shaft thrust plate 364 affixed to and extending radially from rotating shaft 304 within thrust bearing casing 350. Plate 364 may be separate coupled pieces to rotating shaft 304, or it may be integral to rotating shaft 304.

Bearing assembly 302 also includes a first thrust bearing 370 between shaft thrust plate 364 and active side casing thrust plate 360, and a second thrust bearing 372 between shaft thrust plate 364 and inactive side casing thrust plate 362. In conventional arrangements, both thrust bearings 370, 372 would include a tilting pad bearing. In contrast to conventional arrangements, however, thrust bearings 370, 372 are of different types. That is, one is a first type and the other is a second type and the first type is not the second type, for example, the bearings 170, 172 are not both tilting pad thrust bearings. In one embodiment, first thrust bearing 370 includes a conventional tilting pad thrust bearing. One example of a tilting pad thrust bearing 370 is shown in FIG. 3. As understood in the art, tilting pad thrust bearings employ a number of pads 180 that are tiltable relative to a surface 182, i.e., of active side casing thrust plate 360, to bear. A thin film of oil acts to lubricate the surfaces. In one embodiment, second thrust bearing 372 includes a tapered or flat land bearing. One example of a land thrust bearing 372 is shown in FIG. 4. As described herein, land thrust bearing 372 may include a plate 190 having a number of tapered or flat lands 192 on a surface thereof that receive a surface 194, i.e., of inactive side casing thrust plate 362, to bear. A thin film of oil acts to lubricate the surfaces. A land bearing that uses a combination of tapered and flat lands may also be used.

Returning to FIG. 6, land thrust bearing 372 is substantially thinner in an axial direction compared to tilting pad thrust bearing 370, resulting in an asymmetrical arrangement relative to shaft thrust plate 364, collar 354 and/or foundation structure 356. This situation is non-existent in conventional bearing assemblies. In one embodiment, to accommodate the asymmetrical arrangement, shaft thrust plate 364 is disposed closer to inactive side casing thrust plate 362 than to active side casing thrust plate 360. That is, shaft thrust plate 364 is asymmetrically disposed relative to collar 354 and/or foundation structure 356 so as to have a surface 396 thereof closer to inactive side casing thrust plate 362 compared to an opposing surface 398 thereof distance to active side casing thrust plate 360. In addition, as shown in FIG. 6, one or more spacers or shims 374 and/or 376 may be provided to allow for proper positioning of parts. Each spacer 374 or 376 may include a collar having an aperture therethrough for rotating shaft 304.

In operation, active side casing thrust plate 360 may receive axial force F1, which is substantially larger than and more consistent than axial thrust force F2 received by inactive side casing thrust plate 362. More specifically, as axial force F1 load is exerted between active side casing thrust plate 360 and shaft thrust plate 364, and first thrust bearing 370 includes a bearing of a type, e.g., a tilting pad bearing, sufficiently structurally robust to absorb force F1. In contrast, axial force F2 load is exerted between inactive side casing thrust plate 362 and shaft thrust plate 364, and second thrust bearing 372 includes a bearing of a type, e.g., a land bearing, sufficiently structurally robust to absorb the lesser, transient force F2.

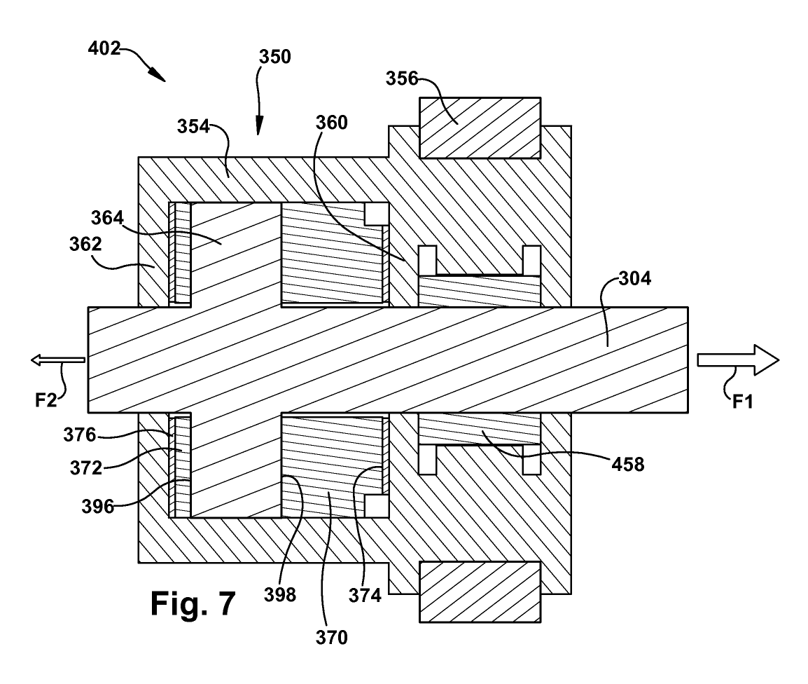

FIG. 7 shows a cross-sectional view of another embodiment of a bearing assembly 402. Bearing assembly 402 is substantially similar to bearing assembly 302 of FIG. 6, except that thrust bearing casing 350 includes a journal bearing 458 positioned therein. In this fashion, bearing assembly 402 performs the same functions as that described above for bearing assembly 302, and also provides rotational support to rotating shaft 304.

Although FIG. 1 shows use of bearing assembly 102 of FIG. 2 only, it is understood that any of bearing assemblies 202, 302, 402 described herein are equally applicable.

An advantage that may be realized in the practice of some embodiments of the described systems and techniques is removal of duplicate tilting pad (or similarly complex, heavier duty) bearings. Consequently, a bearing assembly as described herein may reduce expense since the land (or similarly less complex, lighter duty) bearing is less complex and smaller in size. Furthermore, conventional tilting pad thrust bearings typically exhibit higher oil flow requirements and higher power loss, compared to land bearings. Consequently, a bearing assembly as described herein may reduce oil flow requirements and may reduce power loss. In addition, land bearings require less material to build, which may allow for smaller supporting components and reduced maintenance. Since a tilting pad thrust bearing typically has an overall thickness of as much as 6 inches compared to a 1.5-inch thickness for land thrust bearing of similar capacity and application, the length of bearing assembly may be reduced. This reduction in length consequently may reduce the overall length of machine 100.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A bearing assembly comprising:
a thrust bearing casing surrounding a rotating shaft at a location intermediate ends of the rotating shaft, the rotating shaft including an active side shaft thrust plate and an inactive side shaft thrust plate, each of the active side and the inactive side shaft thrust plate affixed to and extending radially from the rotating shaft, wherein the active side shaft thrust plate receives a substantially larger axial force compared to the inactive side shaft thrust plate during operation of the rotating shaft;
a first thrust bearing between the thrust bearing casing and the active side shaft thrust plate; and
a second thrust bearing between the thrust bearing casing and the inactive side shaft thrust plate,
wherein the first thrust bearing and the second thrust bearing are of a different type.

2. The bearing assembly of claim 1, wherein the first thrust bearing includes a tilting pad bearing, and the second thrust bearing includes a land bearing including at least one of a tapered land and a flat land.

3. The bearing assembly of claim 2, further comprising at least one of:
at least one spacer positioned between the land bearing and the thrust bearing casing; and
at least one spacer positioned between the tilting pad bearing and the thrust bearing casing.

4. The bearing assembly of claim 1, wherein the thrust bearing casing includes a casing thrust plate upon which the bearings act and a collar, and wherein the casing thrust plate is asymmetrically disposed relative to the collar.

5. The bearing assembly of claim 4, wherein the casing thrust plate is disposed closer to the inactive side shaft thrust plate than to the active side shaft thrust plate.

6. The bearing assembly of claim 1, wherein the thrust bearing casing includes a journal bearing for rotationally supporting the rotating shaft.

7. A machine comprising:
a rotating shaft including an active side shaft thrust plate and an inactive side shaft thrust plate, each of the active side and the inactive side shaft thrust plate affixed to and extending radially from the rotating shaft, wherein the active side shaft thrust plate receives a substantially larger axial force compared to the inactive side shaft thrust plate during operation of the rotating shaft;
a bearing assembly for supporting the rotating shaft, the bearing assembly including:
a thrust bearing casing surrounding the rotating shaft at a location intermediate ends of the rotating shaft,
a first thrust bearing between the thrust bearing casing and the active side shaft thrust plate; and
a second thrust bearing between the thrust bearing casing and the inactive side shaft thrust plate,
wherein the first thrust bearing and the second thrust bearing are of a different type.

8. The machine of claim 7, wherein the first thrust bearing includes a tilting pad bearing, and the second thrust bearing includes a land bearing.

9. The machine of claim 8, further comprising at least one of:
at least one spacer positioned between the land bearing and the thrust bearing casing; and
at least one spacer positioned between the tilting pad bearing and the thrust bearing casing.

10. The machine of claim 8, wherein the thrust bearing casing includes a casing thrust plate upon which the bearings act and a collar, and wherein the casing thrust plate is asymmetrically disposed relative to the collar.

11. The machine of claim 10, wherein the casing thrust plate is disposed closer to the inactive side shaft thrust plate than to the active side shaft thrust plate.

12. The machine of claim 7, wherein the machine includes a turbo machine including a plurality of blades coupled to the rotating shaft for imparting rotation to the rotating shaft from a source of operative fluid.

13. The machine of claim 7, wherein the thrust bearing casing includes a journal bearing for rotationally supporting the rotating shaft.

14. A bearing assembly comprising:
a thrust bearing casing surrounding a rotating shaft, the thrust bearing casing including an active side casing thrust plate and an inactive side casing thrust plate, each of the active side and the inactive side casing thrust plate extending radially toward a rotating shaft, the rotating shaft including a shaft thrust plate affixed to and extending radially from the rotating shaft within the thrust bearing casing, wherein the active side casing thrust plate receives a substantially larger axial force compared to the inactive side casing thrust plate during operation of the rotating shaft;
a first thrust bearing between the shaft thrust plate and the active side casing thrust plate; and
a second thrust bearing between the shaft thrust plate and the inactive side casing thrust plate,
wherein the first thrust bearing and the second thrust bearing are of a different type.

15. The bearing assembly of claim 14, wherein the first thrust bearing includes a tilting pad bearing, and the second thrust bearing includes a land bearing.

16. The bearing assembly of claim 14, further comprising at least one of:
at least one spacer positioned between the land bearing and the shaft thrust plate; and
at least one spacer positioned between the tilting pad bearing and the shaft thrust plate.

17. The bearing assembly of claim 14, wherein the shaft thrust plate is asymmetrically disposed relative to the thrust bearing casing.

18. The bearing assembly of claim 14, wherein the thrust bearing casing further includes a journal bearing for rotationally supporting the rotating shaft.
